(19) United States
(12) Patent Application Publication
(10) Pub. No.: US 2010/0184493 A1
(43) Pub. Date: Jul. 22, 2010

(54) MOBILE PHONE

(76) Inventors: Chien-Hung LIN, Tu-Cheng City (TW); Hung-Jen Chen, Tu-Cheng City (TW); Yu-Yuan Wu, Tu-Cheng City (TW)

Correspondence Address: Muncy, Geissler, Olds & Lowe, PLLC, 4000 Legato Road, Suite 310, FAIRFAX, VA, 22033, US

(21) Appl. No.: 12/357,757

(22) Filed: Jan. 22, 2009

(51) Int. Cl. H04M 1/02

(52) U.S. Cl. 455/575.7

(57) ABSTRACT

A mobile phone has a housing and an antenna assembly configured in the housing. The housing has a front portion, a rear portion, a top portion, a bottom portion and a side portion. The antenna assembly has a telecommunication antenna operating as at least one wireless telecommunication band, a short range antenna operating as at least one wireless short range communication band, a first broadcast receiving antenna operating at first broadcast band and a second broadcast receiving antenna operating at second broadcast band. The first broadcast band is lower than the second broadcast band. Each of the antennas is configured in at lest one of the portions of the housing. The mobile phone operates at diverse wireless communication systems by using the antennas. The antennas are dispersed in the mobile phone for reducing electromagnetic interference and size of the mobile phone.

### BACKGROUND OF THE INVENTION

1. Field of the Invention

The invention relates to a mobile phone. More specifically, a mobile phone is configured with diverse antennas for operating at diverse wireless communication bands.

2. The Related Art

According to the progress of the communication technology, the key development is the transfer from wired to wireless communication. A plurality of different wireless communication bands may be used by mobile phones. For example, the standards for wireless local area network (WLAN) include the IEEE 802.11a operating at 5.8 GHz band and the IEEE 802.11b/g operating at 2.4 GHz band, the standards for telecommunications include the global system for mobile communication (GSM) operating at GSM 850 MHz, EGSM 900 MHz, DCS 1800 MHz, PCS 1900 MHz and UMTS 2100 MHz bands, and the standards for wireless broadcast includes audio broadcasts operating at amplitude modulation band (AM, 558 KHz˜1494 KHz) and frequency modulation band (FM, 89 MHz˜108 MHz).

Generally speaking, the mobile phone is only configured with a telecommunication antenna for operating at GSM bands. In order to operate at others wireless communication bands, the mobile phone is attached by many exterior antennas. Since, it is inconvenient to carry the exterior antennas. Moreover, the mobile phone has a larger dimension according to the exterior antennas attached to the mobile phone.

Therefore, it is a key development to configure diverse antennas in the mobile phone for reducing size, and the mobile phone can operate at diverse wireless communication systems described above by using the diverse antennas.

### SUMMARY OF THE INVENTION

An object of the present invention is to provide a mobile phone capable of operating at diverse wireless communication systems by using diverse antennas configured in the mobile phone. The diverse antennas are dispersed in the mobile phone for reducing electromagnetic interference of the diverse antennas and the size of the mobile phone.

According to the invention, the mobile phone has a housing and an antenna assembly configured in the housing. The housing has a front portion, a rear portion, a top portion, a bottom portion and a side portion. The front portion is opposite to the rear portion. The top portion and the bottom portion are connected to the front portion and the rear portion, and opposite to each other. The side portion connects to the front portion, the rear portion, the top portion and the bottom portion.

The antenna assembly has a telecommunication antenna, a short range antenna, a first broadcast receiving antenna and a second broadcast receiving antenna. The telecommunication antenna operates as at least one wireless telecommunication band. The short range antenna operates as at least one wireless short range communication band. The first broadcast receiving antenna and the second broadcast receiving antenna operate at a first broadcast band and a second broadcast band respectively. The first broadcast band is lower than the second broadcast band.

Each of the telecommunication antenna, such as the short range antenna, the first broadcast receiving antenna and the second broadcast receiving antenna is configured in at lest one of the front portion, the rear portion, the top portion, the bottom portion and the side portion of the housing.

### BRIEF DESCRIPTION OF THE DRAWINGS

The present invention will be apparent to those skilled in the art by reading the following description of preferred embodiments thereof, with reference to the attached drawings, in which:

FIG. 1 shows a plate-like mobile phone according to the present invention;

FIG. 2 shows an antenna assembly configured in the plate-like mobile phone in FIG. 1 according to the present invention;

FIG. 3 shows the antenna assembly configured in a folded mobile phone according to the present invention;

FIG. 4 shows a slid mobile phone according to the present invention;

FIG. 5 shows the antenna assembly configured in the slid mobile phone in FIG. 4 according to the present invention;

FIG. 6 shows an efficiency test chart of a telecommunication antenna of the antenna assembly;

FIG. 7 shows an efficiency test chart of a short range antenna of the antenna assembly;

FIG. 8 shows a Received Signal Strength Indication (RSSI) test chart of a first broadcast receiving antenna of the antenna assembly; and

FIG. 9 shows a Received Signal Strength Indication (RSSI) test chart of a second broadcast receiving antenna of the antenna assembly.

### DETAILED DESCRIPTION OF THE PREFERRED EMBODIMENT

A mobile phone has a housing and an antenna assembly 1 configured in the mobile phone. The antenna assembly may be configured in the housing or integrated with the housing.

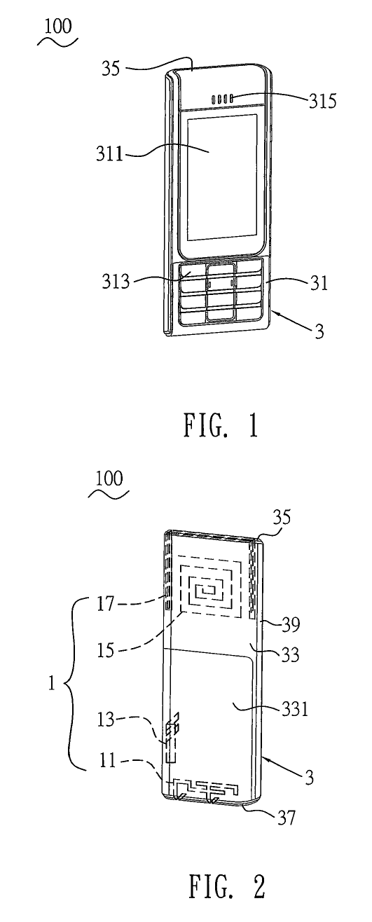

Please refer to FIG. 1 and FIG. 2. A first embodiment of the mobile phone is a plate-like mobile phone 100 having a housing 3 and the antenna assembly 1 configured in the housing 3. The antenna assembly 1 has a plurality of internal antennas including a telecommunication antenna 11, a short range antenna 13, a first broadcast receiving antenna 15 and a second broadcast receiving antenna 17.

Each of the telecommunication antenna 11, the short range antenna 13, the first broadcast receiving antenna 15 and the second broadcast receiving antenna 17 may be one of a micro-strip antenna, a monopole antenna, a dipole antenna, a planar inverted F antenna (PIFA), a spiral antenna, a meandering antenna, a loop antenna, and etc.

The telecommunication antenna 11 may operate at GSM bands including GSM 850 MHz, EGSM 900 MHz, DCS 1800 MHz, PCS 1900 MHz, UMTS 2100 MHz, and etc. Specially, the telecommunication antenna 11 is a micro-strip antenna having a plurality of radiating strips. Each radiating strip resonates to correspond to at least one GSM band. Therefore, the telecommunication antenna 11 can operate at GSM bands described above.

The short range antenna 13 may operate at wireless local network bands including ISM band, RFID band, etc. Specially, the short range antenna 13 is a FIPA operating at industrial scientific medical (ISM) 2.4 GHz band. Moreover, the short range antenna can operate at RFID 2.4 GHz band.

The first broadcast receiving antenna 15 may operate at one of audio broadcast bands including AM band and FM band, and video broadcast bands including very high frequency band (VHF, 174 MHz˜210 MHz) and ultra high frequency band (UHF, 584 MHz˜710 MHz). The second broadcast receiving antenna 17 may operate at another one of the audio broadcast bands and video broadcast bands described above.

Specially, the first broadcast receiving antenna 15 is a spiral antenna in a rectangular shape. The first broadcast receiving antenna 15 operates at AM band. The second broadcast receiving antenna 17 is a meandering antenna in a long-and-thin shape. The second broadcast antenna 17 operates at FM band.

In this embodiment, the dimension of the first broadcast receiving antenna 15 is the largest, the dimension of the second broadcast receiving antenna 17 is smaller than the first broadcast receiving antenna 15, the dimension of the telecommunication antenna 11 is smaller than the second broadcast receiving antenna 17, and the dimension of the short range antenna 13 is the smallest.

The housing 3 of the plate-like mobile phone 100 has a front portion 31, a rear portion 33, a top portion 35, a bottom portion 37 and a side portion 39. The front portion 31 arranges a display module 311, a keyboard module 313 and a speaker 315. The rear portion 33 is opposite to the front portion 31 and arranged a battery cover 331. The top portion 35 and the bottom portion 37 are opposite to each other and connect to the front portion 31 and the rear portion 33. The side portion 39 connects the front portion 31, the rear portion 33, the top portion 35 and the bottom portion 37.

For the health concern toward the Specific Absorption Rate (SAR) of the telecommunication antenna 11, the telecommunication antenna 11 had better be far from human head. Therefore, the telecommunication antenna 11 is configured in the bottom portion 37 of the housing 3 of the plate-like mobile phone 100 to keep far away from the speaker 315 near the top portion 35 for reducing SAR of the telecommunication antenna 11.

For designing the dimension of the short range antenna 13 to be as small as possible, the short range antenna 13 is configured in the rear portion 33 and near the side portion 39. Considering the dimension, the shape and the efficiency of the first broadcast receiving antenna 15, the second broadcast receiving antenna 17 is configured in the rear portion 33. Specially, the first broadcast receiving antenna 15 is configured in the battery cover 311.

Another design for the second broadcast receiving antenna 17 is that the second broadcast receiving antenna 17 configured in the top portion 35 and the side portion 39. The electromagnetic interference of the telecommunication antenna 11, the short range antenna 13, the first broadcast receiving antenna 15 and the second broadcast receiving antenna 17 are reduced due to the antennas 11, 13, 15, 17 respectively dispersed in the housing 3 of the plate-like mobile phone 100.

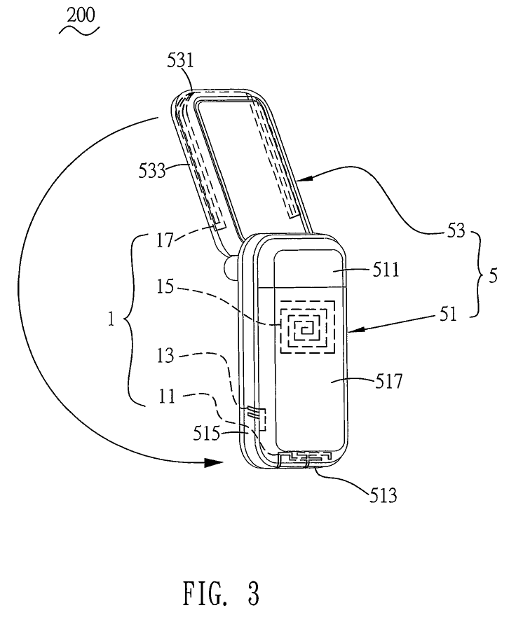

Please refer to FIG. 3. A second embodiment of the mobile phone is a folded mobile phone 200 having a housing 5 and the antenna assembly 1 configured in the housing 5. The housing 5 includes a main case 51 and a sub case 53 folded with respect to the main case 51. The main case 51 has a front portion (not shown in figures), a rear portion 511, a top portion, a bottom portion 513, and a side portion 515.

The front portion may arrange a keyboard module (not shown in figures). The rear portion 511 is opposite to the front portion and has a battery cover 517. The bottom portion 513 and the top portion are opposite to each other and connect the front portion and the rear portion 511. The side potion 515 connects with the front portion, the rear portion 511, the top portion and the bottom portion 513.

The sub case 53 has a front portion (not shown in figures), a top portion 531, a bottom portion and a side portion 533. The front portion may arrange a display module and a speaker (not shown in figures). Between the top portion of the main case 51 and the bottom portion of the sub case 53 is a hinge (not shown in figures) for foldable coupling the main case 51 and the sub case 53 to each other.

While the sub case 53 is folded and covered on the main case 51, the top portion 531 of the sub case 53 is corresponding to the bottom portion 513 of the main case 51, and the side portion 533 of the sub case 53 is corresponding to the side portion 515 of the main case 51.

As described above, considering the antenna characteristic, the dimension and the shape of the telecommunication antenna 11, the short range antenna 13, the first broadcast receiving antenna 15 and the second broadcast receiving antenna 17 are dispersed in the housing 5 of the folded mobile phone 200.

In this embodiment, the telecommunication antenna 11 is configured in the rear portion 511 and near the bottom portion 513 of the main case 51. The short antenna 13 is configured in the rear portion 511 and near the side portion 515 of the main case 51. The first broadcast receiving antenna 15 is configured in the rear portion 511 of the main case 51. The second broadcast receiving antenna 17 is configured in the top portion 531 and the side portion 533 of the sub case 53. Specially, the first broadcast receiving antenna 15 is configured in the battery cover 517.

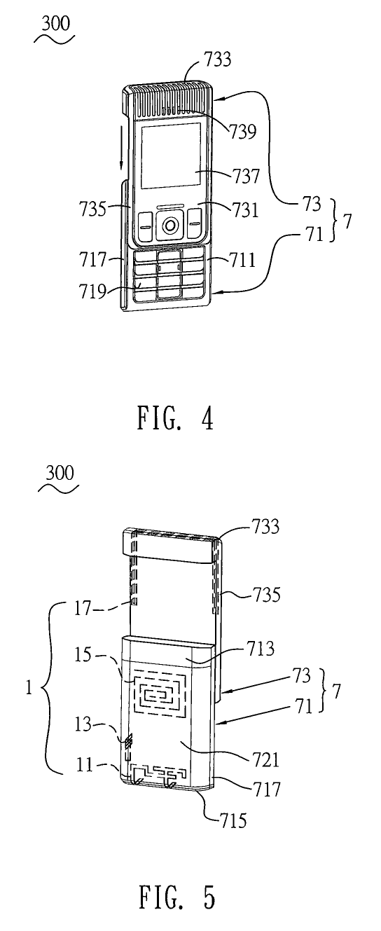

Please refer to FIG. 4 and FIG. 5. A third embodiment is shown. The mobile phone is a slid mobile phone 300 having a housing 7 and the antenna assembly 1 configured in the housing 7. The housing 7 includes a main case 71 and a sub case 73 slid with respect to the main case 71. The main case 71 has a front portion 711, a rear portion 713, a top portion, a bottom portion 715, and a side portion 717.

The front portion 711 may arrange a keyboard module 719. The rear portion 713 is opposite to the front portion 711 and has a battery cover 721. The bottom portion 715 and the top portion are opposite to each other and connect the front portion 711 and the rear portion 713. The side potion 717 connects the front portion 711, the rear portion 713, the top portion and the bottom portion 715.

The sub case 73 has a front portion 731, a rear portion 713, a top portion 733, a bottom portion 715 and a side portion 735. The front portion 731 may arrange a display module 737 and a speaker 739. Between the front portion 711 of the main case 71 and the rear portion 713 of the sub case 73 is a hinge for slideable coupling the main case 71 and the sub case 73 to each other.

While the sub case 73 is slid and fully covered on the main case 71, the top portion 733 of the sub case 73 is corresponding to the top portion of the main case 71, and the side portion 735 of the sub case 73 is corresponding to the side portion 717 of the main case 71.

As described above, considering the antenna characteristic, the dimension and the shape of the telecommunication antenna 11, the short range antenna 13, the first broadcast receiving antenna 15 and the second broadcast receiving antenna 17, the antennas 11, 13, 15 17 are dispersed in the housing 4 of the slid mobile phone 300.

In this embodiment, the telecommunication antenna 11 is configured in the rear portion 713 and near the bottom portion 715 of the main case 71. The short antenna 13 is configured in the rear portion 713 and near the side portion 717 of the main case 71. The first broadcast receiving antenna 15 is configured in the rear portion 713 of the main case 71. The second broadcast receiving antenna 17 is configured in the top portion 733 and the side portion 735 of the sub case 73.

Specially, the first broadcast receiving antenna 15 is configured in the battery cover 721. The telecommunication antenna 11 can extend in the bottom portion 71 of the main case 715. The short range antenna 13 can extend in the side portion 717 of the main case 71.

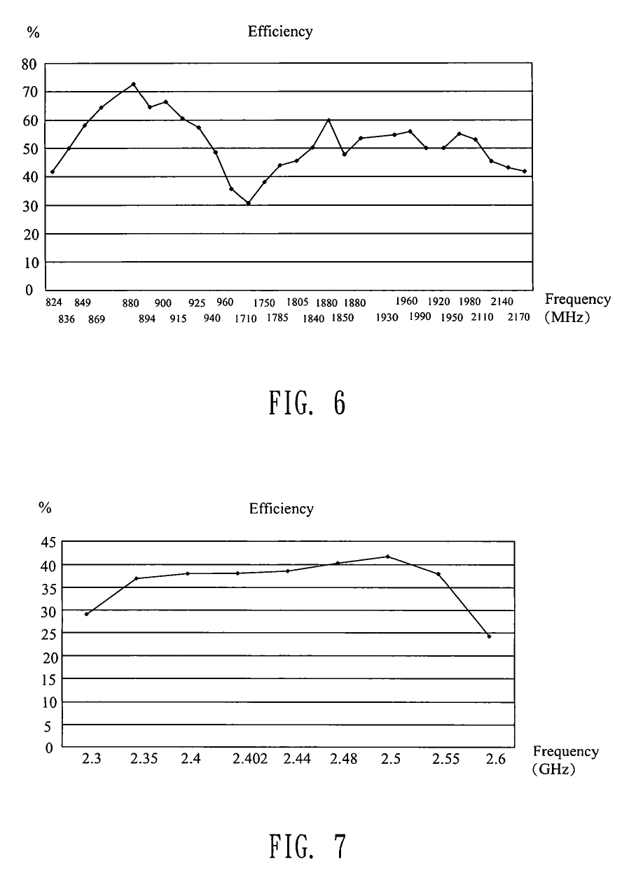

Please refer to FIG. 6, which shows an efficiency test chart of the telecommunication antenna 11. While the telecommunication antenna 11 is the micro-strip antenna and configured in the rear portion and near the bottom portion of the housing of the mobile phone, the efficiency of the telecommunication antenna 11 operating at GSM bands between 824 MHz and 2170 MHz is between 31 percents and 73 percents.

Please refer to FIG. 7, which shows an efficiency test chart of the short range antenna 13. While the short range antenna 13 is the PIFA and configured in the rear portion and near the side portion of the housing of the mobile phone, the efficiency of the short range antenna 13 operating at ISM band between 2.4 GHz and 2.48 GHz is between 38 percents and 40 percents.

Please refer to FIG. 8, which shows a received signal strength indication (RSSI) test chart of the first broadcast receiving antenna 15. While the first broadcast receiving antenna 15 is the spiral antenna and configured in the rear portion of the housing of the mobile phone, the average RSSI of the first broadcast receiving antenna 15 operating at AM band between 558 KHz and 1494 KHz is 29 dBm.

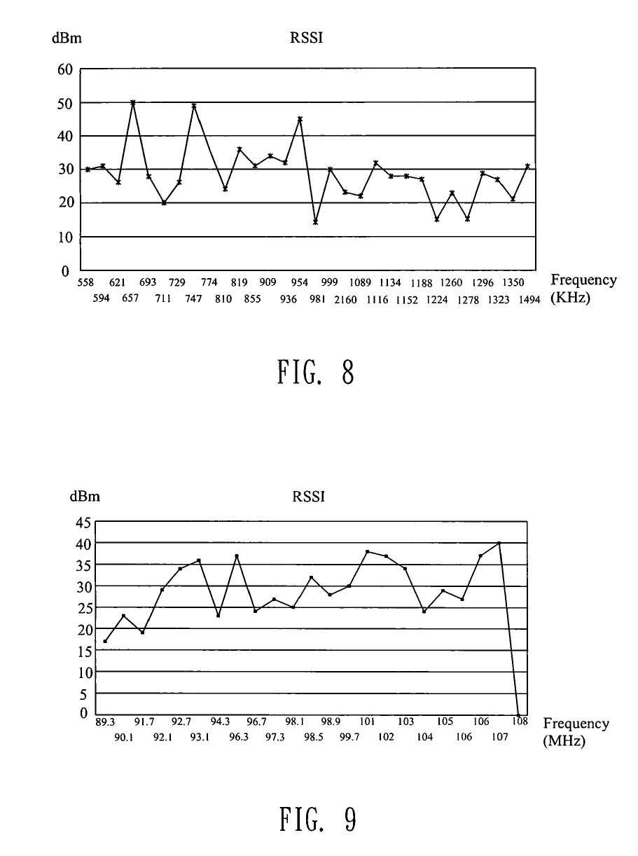

Please refer to FIG. 9, which shows a RSSI test chart of the second broadcast receiving antenna 17. While the second broadcast receiving antenna 17 is the meandering antenna and configured in the top portion and the side portion of the housing of the mobile phone, the average RSSI of the second broadcast receiving antenna 17 operating at FM band between 89 MHz and 108 MHz is 28 dBm.

The telecommunication antenna 11, the short range antenna 13, the first broadcast receiving antenna 15 and the second broadcast receiving antenna 17 can be printed on a circuit board, specially, a flexible circuit board and adhered on an inner surface of the housing of the mobile phone for reducing size. Moreover, the telecommunication antenna 11, the short range antenna 13, the first broadcast receiving antenna 15 and the second broadcast receiving antenna 17 can be integrated with the housing of the mobile phone.

As described above, considering the dimension requirement and downing size purpose of each of the telecommunication antenna 11, the short range antenna 13, the first broadcast receiving antenna 15 and the second broadcast receiving antenna 17 of the antenna assembly 1 for operating at corresponding wireless communication system, each of the antennas 11, 13, 15, 17 is designed to a specially type.

The antennas 11, 13, 15, 17 are dispersed in special positions of the housing of the mobile phone respectively for reducing electromagnetic interference of the antennas 11, 13, 15, 17 and size of the mobile phone. Therefore, the mobile phone operates at diverse communication systems including GSM system, wireless local area network systems and broadcasting systems by using the antenna assembly 1.

Furthermore, the present invention is not limited to the embodiments described above; diverse additions, alterations and the like may be made within the scope of the present invention by a person skilled in the art. For example, respective embodiments may be appropriately combined.

What is claimed is:

1. A mobile phone having a housing having a front portion, a rear portion opposite the front portion, a top portion connecting to the front portion and the rear portion, a bottom portion opposite to the top portion, a side portion connecting to the front portion, the rear portion, the top portion and the bottom portion, and a speaker placed near the top portion, comprising:
a telecommunication antenna operating as at least one wireless telecommunication band and configuring in the rear portion and near the bottom portion for keeping away from the speaker;
a short range antenna operating as at least one wireless short range communication band and configuring in the rear portion and near the side portion of the housing;
a first broadcast receiving antenna operating at first broadcast band and configuring in the rear portion of the housing;
a second broadcast receiving antenna operating at second broadcast band and configuring in the top portion and the side portion of the housing.

2. The mobile phone as claimed in claim 1, wherein the telecommunication antenna is a micro-strip antenna.

3. The mobile phone as claimed in claim 2, wherein the telecommunication antenna is a multi-band antenna.

4. The mobile phone as claimed in claim 3, wherein the telecommunication antenna extends in the bottom portion of the housing.

5. The mobile phone as claimed in claim 1, wherein the short range antenna is an inverted F antenna.

6. The mobile phone as claimed in claim 5, wherein the short range antenna operates at 2.4 GHz.

7. The mobile phone as claimed in claim 6, wherein the short range antenna extends in the side portion of the housing.

8. The mobile phone as claimed in claim 1, wherein the first broadcast receiving antenna is a spiral antenna.

9. The mobile phone as claimed in claim 8, wherein the first broadcast receiving antenna is in a rectangular shape.

10. The mobile phone as claimed in claim 9, wherein the first broadcast receiving antenna operates at amplitude modulation band.

11. The mobile phone as claimed in claim 1, further comprising a battery cover arranged at the rear portion of the housing, the first broadcast receiving antenna is configured in the battery cover.

12. The mobile phone as claimed in claim 1, wherein the second broadcast receiving antenna is a meandering antenna.

13. The mobile phone as claimed in claim 12, wherein the second broadcast receiving antenna is in a thin-and-long shape.

14. The mobile phone as claimed in claim 13, wherein the second broadcast receiving antenna operates at frequency modulation band.

15. The mobile phone as claimed in claim 14, wherein the housing has a main case and a sub case folded with respect to the main case, the second broadcast receiving antenna is configured in the top portion and the side portion of the sub case of the housing.
